(19) United States
(12) Patent Application Publication
(10) Pub. No.: US 2014/0006292 A1
(43) Pub. Date: Jan. 2, 2014

(54) DECISION PROCEDURE FOR CUSTOMER ISSUE RESOLUTION

(71) Applicant: EMC CORPORATION, Hopkinton, MA (US)

(72) Inventors: Vitaly S. Kozlovsky, St. Petersburg (RU); Artem Zarafyants, St. Petersburg (RU); Dmitry N. Tylik, St. Petersburg (RU)

(73) Assignee: EMC CORPORATION, Hopkinton, MA (US)

(21) Appl. No.: 13/783,622

(22) Filed: Mar. 4, 2013

Related U.S. Application Data
(63) Continuation of application No. PCT/RU2012/000521, filed on Jun. 29, 2012.

(51) Int. Cl. G06Q 30/00

(52) U.S. Cl. CPC G06Q 30/016
USPC 705/304

(57) ABSTRACT

An improved technique involves providing a decision procedure to determine whether an unsolved customer problem goes to a public problem-solving forum or internal support. For example, when a support center receives a customer problem and determines that the problem does not have a known solution, it assigns a severity weight to the problem based on a description of the problem. Along these lines, suppose that the call center receives a customer problem regarding excessive down time. When the call center places the problem into a “downtime” classification, the call center counts how many other unsolved “downtime” problems are awaiting solution. If there are not many similar problems awaiting solution, then the call center assigns a high severity level and assigns the task of solving the problem to a public forum, such as a crowdsourcing application.

### CROSS-REFERENCE TO RELATED APPLICATIONS

This Application claims the benefit under 35 U.S.C. §120 of PCT International Patent Application No. PCT/RU2012/000521 filed on Jun. 29, 2012, entitled “DECISION PROCEDURE FOR CUSTOMER ISSUE RESOLUTION”.

### BACKGROUND

Some customers who experience issues with complex technology products submit tickets to a call center to resolve the issues. The customers describe the issues in the tickets in such a way as to facilitate troubleshooting the problem. Along these lines, consider a customer experiencing an issue with a storage system product. For example, the customer has noticed that the data recovery rate of the storage system has been relatively slow over a period of a day, and has no explanation for this slow recovery rate. The customer describes the magnitude of the reduced recovery rate, as well as other possible mitigating factors (e.g., data type, network type, etc.) in a web form. A browser script then generates and sends a ticket to the call center.

A conventional approach to addressing customer issues involves determining whether a solution to an issue described in a ticket exists in a database accessible to the call center. In the conventional approach, if the call center cannot match a solution to the issue in the database as described in the ticket, then the call center places the ticket into a queue attended by an internal support team—that is, a support team that belongs to the company that produces the complex technology product with which the issue is associated.

In the conventional approach to addressing customer issues, the call center places the ticket into a bucket based on the description of the issue in the ticket. In this way, the ticket is more likely to go to a part of the internal support team best qualified to address the issue.

### SUMMARY

Unfortunately, there are deficiencies with the above-described conventional approach to addressing customer issues. For example, the conventional approach to addressing customer issues relies on the company having an internal support team capable of addressing all unsolved customer issues. For sufficiently complex technology products, however, the number of unsolved issues frequently overwhelms an internal support team. Although the company attempts to anticipate staffing needs for the internal support team for a particular product, such attempts tend to err with respect to staffing levels. Accordingly, it is common for turnaround time for such customer issues to be longer than what many customers would consider reasonable.

It should be understood that placing tickets into buckets, while directing issues to the best areas of expertise of the internal support team, is not a panacea for overwhelmed internal support teams. For example, on one day, there may be several issues involving data recovery rates; in such a case, the particular experts in the internal support team on these types of issues will be overwhelmed while other areas of the team may be idle. On another day, data recovery rate issues may be few while uptime issues may dominate. It is difficult for a company to anticipate such shifts in needed expertise.

In contrast to conventional approaches to addressing customer issues in which internal support teams that address issues in complex technology products frequently become overwhelmed, an improved technique involves providing a decision procedure to determine whether an unsolved customer problem goes to a public problem-solving forum or internal support. For example, when a support center receives a customer problem and determines that the problem does not have a known solution, it assigns a severity weight to the problem based on a description of the problem. Along these lines, suppose that the call center receives a customer problem regarding excessive down time. When the call center places the problem into a “downtime” classification, the call center counts how many other unsolved “downtime” problems are awaiting solution. If there are many such problems awaiting solution, then the call center assigns a high severity level to the received problem and assigns the task of solving the problem to internal support. On the other hand, if there are not many similar problems awaiting solution, then the call center assigns a low severity level and assigns the task of solving the problem to a public forum, such as a crowdsourcing application.

Advantageously, the improved technique allows for more rapid resolution of customer problems. By sending unsolved customer problems having a lesser urgency to a crowdsourced forum, the internal support team can work on solving high-priority problems with a minimum of latency. Further, the company can organize the crowdsourced forum to identify and reward those members that demonstrate an ability to provide useful solutions to customer problems. In this way, there is a greater likelihood of an unsolved customer problem getting solved faster and more reliably.

One embodiment of the improved technique is directed to a method of providing a solution to a customer problem concerning a product to a customer of a company. The method includes receiving, by a controller of a computer system, a message from the customer that includes a description of the customer problem. The method also includes assigning, by the controller, a metric to the customer problem, the metric being based on the description of the customer problem. The method further includes performing, by the controller, a decision procedure based on the metric, the decision procedure being configured to cause the controller to send the message to one of i) internal resources of the company, and ii) external resources outside of the company. The method further includes acquiring, by the controller, the solution of the customer problem from the one of the internal resources and the external resources.

Additionally, some embodiments of the improved technique are directed to a system constructed and arranged to provide a solution to a customer problem concerning a product to a customer of a company. The system includes a network interface, a memory, and a processor coupled to the memory, the processor configured to carry out the method of providing a solution to a customer problem concerning a product to a customer of a company.

Furthermore, some embodiments of the improved technique are directed to a computer program product having a non-transitory computer readable storage medium which stores code including a set of instructions to carry the method of providing a solution to a customer problem concerning a product to a customer of a company.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a block diagram illustrating an example electronic environment for carrying out the improved technique.

FIG. 2 is a block diagram illustrating an example computer system within the electronic environment shown in FIG. 1.

FIG. 3 is a schematic diagram illustrating an example decision procedure carried out from the computer system illustrated in FIG. 1.

FIG. 4 is a schematic diagram illustrating example external resources within the electronic environment shown in FIG. 1.

FIG. 5 is a flow chart illustrating an example method of carrying out the improved technique within the electronic environment shown in FIG. 1.

### DETAILED DESCRIPTION

An improved technique involves providing a decision procedure to determine whether an unsolved customer problem goes to a public problem-solving forum or internal support. For example, when a support center receives a customer problem and determines that the problem does not have a known solution, it assigns a severity weight to the problem based on a description of the problem. Along these lines, suppose that the call center receives a customer problem regarding excessive down time. When the call center places the problem into a “downtime” classification, the call center counts how many other unsolved “downtime” problems are awaiting solution. If there are many such problems awaiting solution, then the call center assigns a high severity level to the received problem and assigns the task of solving the problem to internal support. On the other hand, if there are not many similar problems awaiting solution, then the call center assigns a low severity level and assigns the task of solving the problem to a public forum, such as a crowdsourcing application.

Advantageously, the improved technique allows for more rapid resolution of customer problems. By sending unsolved customer problems having a lesser urgency to a crowdsourced forum, the internal support team can work on solving high-priority problems with a minimum of latency. Further, the company can organize the crowdsourced forum to identify and reward those members that demonstrate an ability to provide useful solutions to customer problems. In this way, there is a greater likelihood of an unsolved customer problem getting solved faster and more reliably.

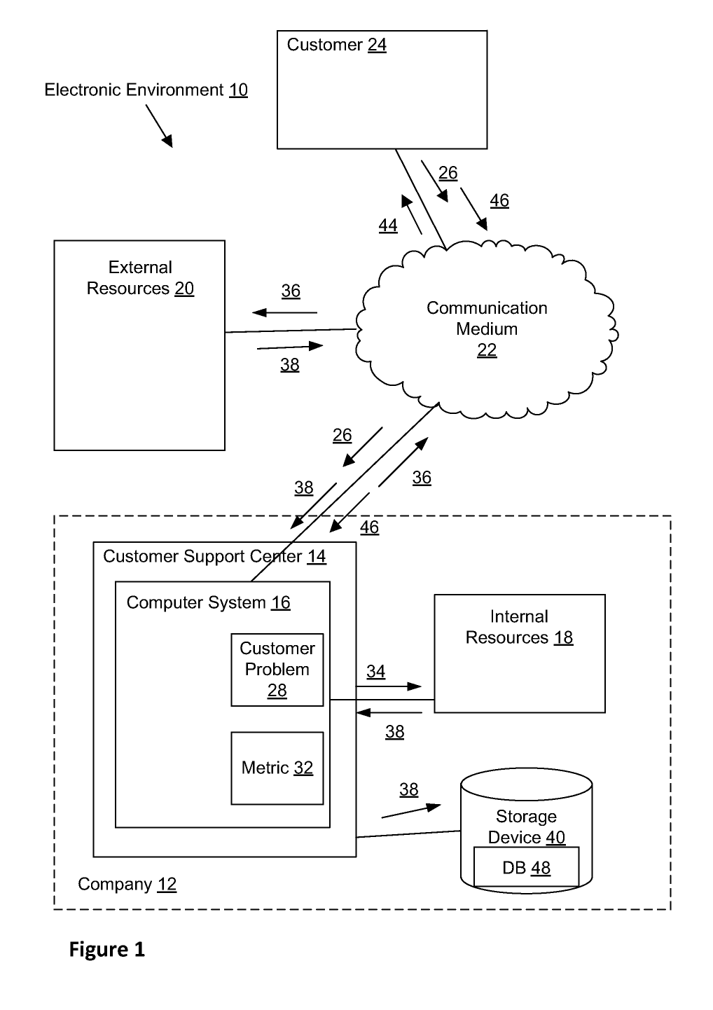

FIG. 1 illustrates an example electronic environment 10 for carrying out the improved technique. Electronic environment 10 includes, within support provider 12, computer system 16, internal resources 18, and storage device 40. Electronic environment 10 further includes external resources 20, communication medium 22, and a customer 24.

Communication medium 22 provides network connections between computer system 16, external resources 20, and customer 24. Communication medium 22 may implement a variety of protocols such as TCP/IP, UDP, ATM, Ethernet, Fibre Channel, combinations thereof, and the like. Furthermore, communication medium 22 may include various components (e.g., cables, switches/routers, gateways/bridges, NAS/SAN appliances/nodes, interfaces, etc.). Moreover, communication medium 22 is capable of having a variety of topologies (e.g., queue manager-and-spoke, ring, backbone, multi drop, point to-point, irregular, combinations thereof, and so on).

Support provider 12 supports, through customer support center 14, the product about which customer 24 describes in a message 26 that contains customer problem 28. Support provider 12 also includes internal resources 18 and storage device 40 on which database 48 is stored.

In some arrangements, customer support center 14 is a manually staffed team dedicated to solving problems concerning the product supported by support provider 12. Customer support center 14 includes at least one computer system 16.

Computer system 16 is constructed and arranged to receive message 26 that contains customer problem 28. Computer system 16 is also constructed and arranged to perform a decision procedure on customer problem 28 to determine whether to send the customer problem to internal resources 18 or external resources 20 for resolution. In some arrangements, computer system 16 takes the form of a server; in other arrangements, computer system 16 is a desktop, laptop, or tablet computer.

Internal resources 18 are configured to draw up solutions to customer problem 28. In some arrangements, internal resources 18 include a team of people solving problems on electronic equipment; in other arrangements, internal resources include automated systems for solving customer problem 28. Database 48 is configured to store solutions to customer problem 28 in storage device 40. Database 48 is also configured to store results of feedback 46 to the solutions.

External resources 20 are configured to draw up solutions to customer problem 28. In some arrangements, external resources include an interface to a crowdsharing application that engages a large number of people not associated with support provider 12 to attempt a solution to customer problem 28.

Customer 24 is configured to send message 26 that contains customer problem 28 to customer support center 14. Customer 24 is further configured to send feedback 46 in response to receiving solution 38 to customer problem 28.

During operation, customer 24 sends a message 26 to customer support center 14 over communication medium 22. For example, customer 24 experienced a slowdown in a data recovery rate on a data storage system supported by support provider 12. In response, customer 24 goes to a customer support website hosted by customer support center in which customer 24 inputs a description of customer problem 28. Upon pressing a submit button, a script in the customer support website generated message 26 containing the description of customer problem 28.

It should be understood that the description of customer problem 28 can take any of several forms. In some arrangements, customer 24 describes customer problem 28 through the use of checkboxes as yes/no responses to questions (e.g., “Is your data recovery rate satisfactory?”). In other arrangements, customer 24 describes problem 28 by drop-down menus over several choices. In these cases, customer 24 describes problem 28 in terms of values of problem parameters. In still other arrangements, however, customer 24 describes problem 28 through natural language descriptions.

Customer support center 14, upon receiving message 26, stores customer problem 28 in computer system 16. In some arrangements, computer system 16 receives message 26 directly from customer 24. Computer system 16 then extracts customer problem 28 from message 26 and stores the description of problem 28 internally.

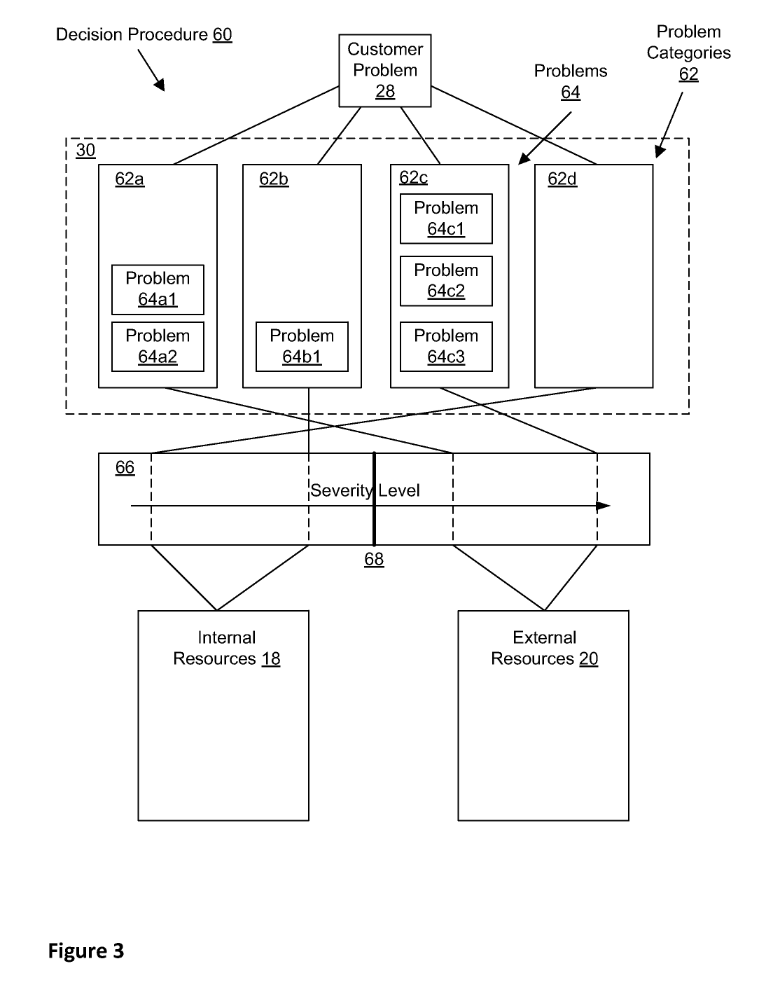

Computer system 16 assigns a metric 32 to customer problem 28 based on the description of the computer problem. In some arrangements, metric 32 includes a severity level indicative of the urgency of providing a solution to problem 28 to customer 24. In some arrangements, the severity level of problem 28 is based on a number of other customers reporting a similar problem. Further details of assigning a severity level to problem 28 are discussed below with respect to FIG. 3.

It should be understood that, in some arrangements, in assigning metric 32 to the customer problem, computer system 16 also verifies that customer problem is unsolved. Specifically, computer system 16 performs a lookup operation on database 48 to verify whether any of the solutions stored in database 48 provide a match to customer problem 28. For example, when customer problem 28 is described through the values of the problem parameters described above, the lookup operation involves checking values of the problem parameters in database 48 against the values of the problem parameters supplied in the description of problem 28.

Computer system 16 performs a decision procedure based on the metric assigned to customer problem 28. A result of the decision procedure is that computer system 16 either sends a message 34 to internal resources 18 or computer 16 sends a message 36 to external resources 20, each of message 34 and message 36 containing descriptions of customer problem 28. In some arrangements, the decision procedure involves comparing the severity level assigned to customer problem 28 to a threshold severity level. If the severity level is less than the threshold severity level, then computer system 16 sends message 36 to external support 20; otherwise, computer system 16 sends message 34 to internal resources 18.

Sometime later, computer system 16 receives solution 38 to customer problem from either of internal resources 18 or external resources 20. In some arrangements, solution 38 includes a sequence of logical steps for customer 24 to take in order to solve problem 28. In other arrangements, solution 38 contains values of answer parameters.

Upon receiving solution 38, computer system 16 sends solution 38 to customer 24 for evaluation. Customer 24 provides feedback 46 regarding solution 38 as to whether solution 38 provided a satisfactory fix to customer problem 28. If feedback 46 indicates that the resulting fix was satisfactory, then computer system 16 stores solution 38 in database 48. Otherwise, computer system 16 alters metric 32 to reflect the fact that a generated solution failed. Along these lines, computer system 16 raises the severity level of problem 28 to reflect an increased urgency. Whereas problem 28 was originally sent to external resources 20 in message 36, problem 28 may be sent instead to internal resources 18.

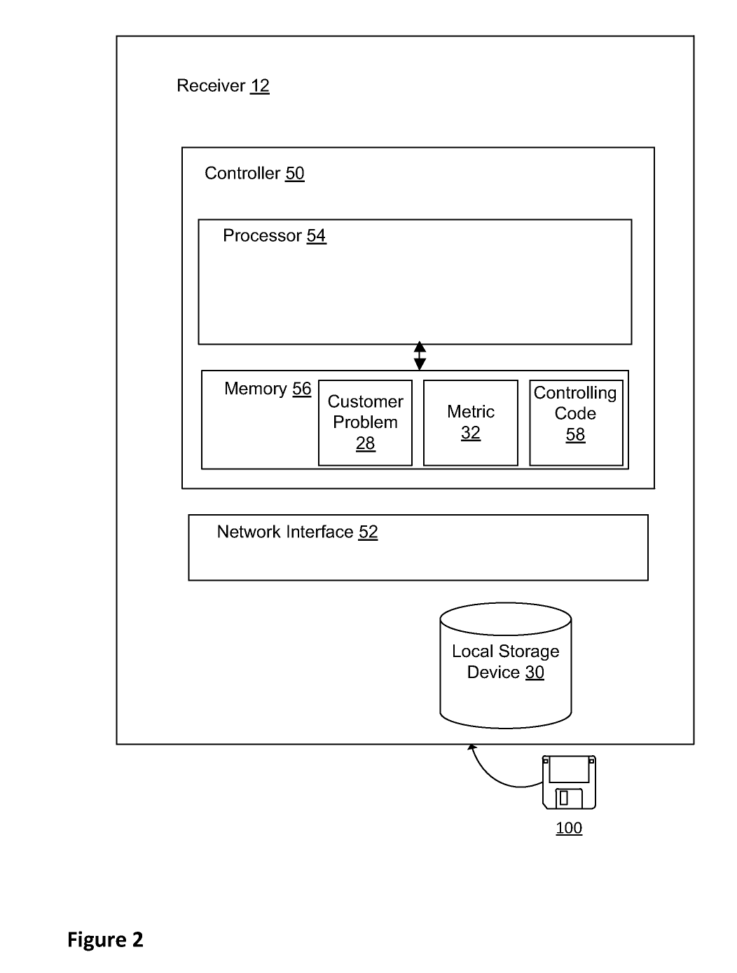

Further details of computer system 16 are discussed below with respect to FIG. 2.

FIG. 2 illustrates an example computer system 16 in further detail. Computer system 16 includes controller 50, which includes processor 54 and memory 56, network interface 52, and local storage device 30.

Memory 56 is configured to store controlling code 58 which includes instructions for providing a solution to a customer problem concerning the product. Memory 56 is further configured to store customer problem 28 and metric 32. Memory 56 generally takes the form of, e.g., random access memory, flash memory, or a non-volatile memory.

Processor 54 takes the form of, but is not limited to, Intel or AMD-based microprocessing units, and can include a single or multi-cores each running single or multiple threads. Processor 54 is coupled to memory 56 and is configured to execute the controlling code 58 stored in memory 56.

Network interface 52 is constructed and arranged to send and receive data over communication medium 22. Specifically, network interface 52 is configured to receive message 26 containing customer problem 28.

Local storage device 30 is configured to store open, unsolved problems. In some arrangements, however, processor 54 distributes different processing tasks among computers forming a cluster in order to share the load among the computers of the cluster.

During operation, processor 54 receives message 26 via network interface 52. Upon receiving message 26, processor 54 extracts customer problem 28 from message 26 and stores customer problem in memory 56. For example, processor 54 extracts values of problem parameters from message 26 and stores the values in memory 56.

Processor 54 assigns metric 32 to customer problem 28 and stores metric 32 in memory 56. For example, processor 54 checks database 48 for similar problems that may have a solution. If no solution exists for the problem (e.g., the values of the problem parameters are not associated with a solution stored in database 48), then processor 54 compares problem 28 to other open problems stored in local storage device 30.

Based on the metric 32 assigned to the customer problem 28, processor 54 performs a decision procedure to decide whether to send customer problem 28 to one of internal resources 18 and external resources 20. Details of an example decision procedure are discussed below with respect to FIG. 3.

FIG. 3 illustrates an example decision procedure 60 for determining whether to send customer problem 28 to one of internal resources 18 and external resources 20. As discussed above, decision procedure 60 depends on comparing customer problem 28 to other problems 64 stored on local storage device 30.

Processor 54 has categorized other problems 64 into problem categories 62. For example, problem categories 62 represent particular classes of values of the problem parameters. To each problem category 62, there correspond various numbers of open problems 64. For example, there are two open problems, 64a1 and 64a2, in category 62a corresponding to downtime in a particular storage system exceeding 5 minutes, but less than 1 hour. There is one problem, 64b1, in category 62b, corresponding to downtime exceeding 1 hour. There are three problems, 64c1, 64c2, 64c3, in category 62c, corresponding to a data recovery rate being less than 10% of the mean rate over the past 30 days. There are no problems in category 62d, corresponding to an overheating of a component of the storage system.

Processor 54, in this example, has matched customer problem 28 to problem category 62c. Based on the number of open problems in category 62c, processor 54 assigns a severity level 66, not only to problem 28, but to category 62c and all problems within category 62c. When problem 28 is added to category 62c, the number of open problems in category 62c has increased and, accordingly, processor 54 adjusts severity 66 level of category 62c and assigns severity level 66 to problem 28.

It should be understood that the ideal is having a single solution apply to all problems within a single category. The effect, then, of assigning a severity level to a category is to assign that severity level to all problems within that category. Nevertheless, a solution found to work for one of the problems in a category may not work for other problems in that category. In such cases, the category may need to be redefined based on the feedback from the solution.

The example scale of severity level 66 illustrated in FIG. 3 shows that severity level 66 depends on the number of open problems 64 in a particular category 62. Those having the most open problems 62 would have the highest severity level, and those having the least open problems would have the lowest severity level. Thus, category 62c has the highest severity level, say severity level seven. Category 62a has the next highest, say, severity level five, followed by category 62b having severity level three, and category 62d having severity level one.

It should be understood that severity level 66 may depend on other factors than number of open problems 64 in a category 62. For example, the nature of problems defining a category 62 may also determine severity level. In the example above, problems involving long downtimes are of a higher urgency than those involving data recovery rates. Moreover, the amount of time that problems 64 are open in a category 62 may also affect severity level because a problem open for a sufficiently long time may cause customer 24 to lose confidence in company 12. In this case, severity level 66 may be increased when the amount of time problems in a category 62 are open becomes larger than a threshold time (say, 48 hours).

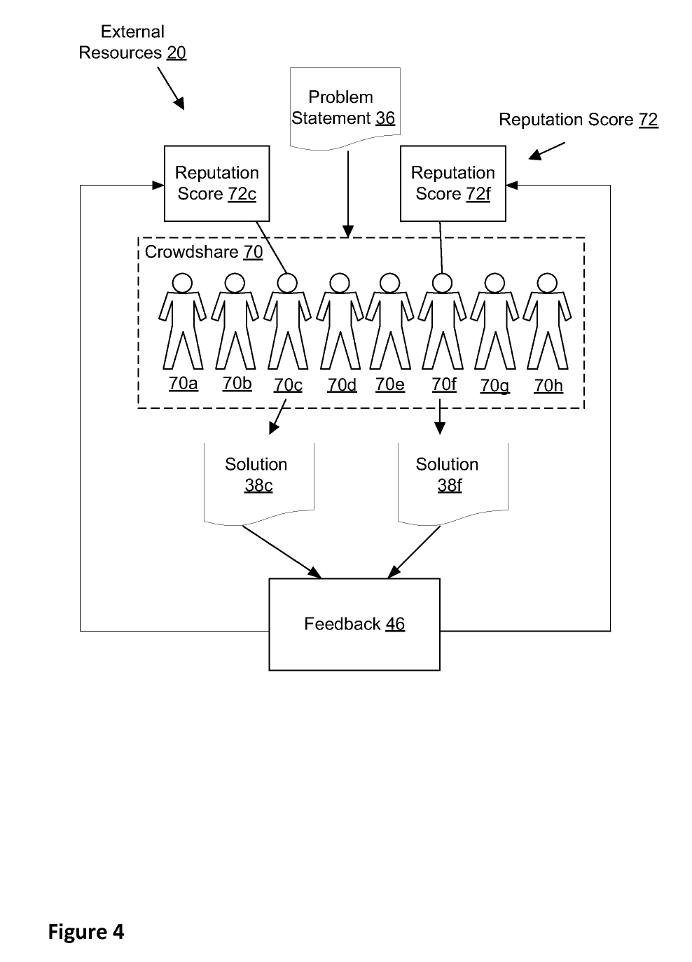

Processor 54 defines a threshold severity level 68 equal to four in this case. Problems 64 in categories 62 having a severity level 66 greater than this threshold 68 will be sent to internal resources 18 for evaluation (the problems most directly affecting customers should be addressed internally). Problems 64 in categories 62 having a severity level 66 less than this threshold 68 will be sent to external resources 20. Further detail about external resources 20 is discussed below with respect to FIG. 4.

FIG. 4 illustrates an example of external resources 20 which includes a crowdshare 70 including crowdshare members 70a, 70b, 70c, 70d, 70e, 70f, 70g, and 70h (members 70). As is known in the art, crowdshare 70 includes an interface that displays problems to particular crowdshare members 70 and coordinates possible solutions. Each crowdshare member has a reputation score 72; based on the reputation score 72, processor 54 authorizes members 70 to submit solutions only for certain problems. A member acquires a reputation score based on the number of correct solutions that member submitted. For example, a member 70c with a high reputation score 72c will be able to solve problems having a greater severity level (say, greater than five), while a member 70f having a lower reputation score 72f will be restricted from submitting solutions having a higher severity level.

Crowdshare 70 receives problem statement 36 that describes customer problem 28. Once the crowdsharing interface extracts problem 28 from statement 36, processor 54, over communication medium 22, determines which members 70 are eligible to work on problem 28 based on severity level 66 (see FIG. 3) assigned to the category 62 to which problem 28 belongs (which is the severity level 66 assigned to problem 28). For example, had problem 28 belonged to category 62c, which had the highest severity level 66, then only member 70c could work on a solution to problem 28. Otherwise, member 70f, with lower reputation score 72f, could work on a solution to problem 28.

When either member 72c or 72f work on a solution to problem 28 and submit respective solutions 38c and 38f, crowdshare 70 receives feedback 46 from customer 24 (see FIG. 1). Based on feedback 46, processor 54 adjusts reputation scores 72c and 72f, respectively. For example, if feedback 46 indicates that solution 38f solved problem 28 to the satisfaction of customer 24, then processor 54 increases reputation score 72f. On the other hand, if feedback 46 indicates that solution 38c did not solve problem 28 to the satisfaction of customer 24, then processor 54 does not adjust, or adjusts downward, reputation score 72f.

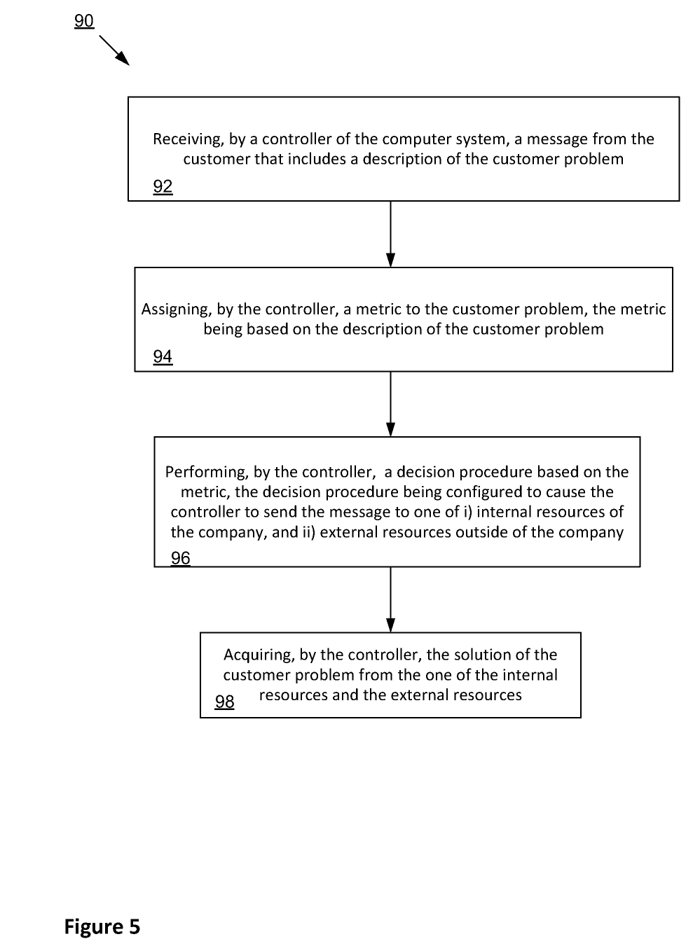

FIG. 5 illustrates a method 90 of providing, to a customer 24 of a support provider 12, a solution to a customer problem 28 concerning a product. In step 92, a message 26 from the customer 24 that includes a description of the customer problem 28 is received. In step 94, a metric 32 is assigned to the customer problem 28, the metric 32 being based on the description of the customer problem 28. In step 96, a decision procedure 60 is performed based on the metric 32, the decision procedure 60 being configured to cause the controller 50 to send i) the message 34 to one of internal resources 18 of the support provider 12, and ii) the message 36 to one of external resources 20 outside of the support provider 12. In step 98, the solution 38 of the customer problem 28 is acquired from the one of the internal resources 18 and the external resources 20.

While various embodiments of the invention have been particularly shown and described, it will be understood by those skilled in the art that various changes in form and details may be made therein without departing from the spirit and scope of the invention as defined by the appended claims.

For example, in the examples above, external resources 20 included crowdsource 70. In some arrangements, however, external resources 20 can include students, consultants, and the like.

Also, metric 32 may include factors other than those described above. For example, there may be security considerations that would prevent customer problem 28 to go to external resources 20.

Furthermore, it should be understood that some embodiments are directed to computer system 16 which is constructed and arranged to provide, to a customer of a company, a solution to a customer problem concerning a product. Some embodiments are directed to computer system 16. Some embodiments are directed to a system which provides a solution to a customer problem concerning a product. Some embodiments are directed to a process of providing a solution to a customer problem concerning a product. Also, some embodiments are directed to a computer program product which enables computer logic to provide a solution to a customer problem concerning a product.

In some arrangements, computer system 16 is implemented by a set of processors or other types of control/processing circuitry running software. In such arrangements, the software instructions can be delivered to computer system 16 in the form of a computer program product 100 (FIG. 2) having a computer readable storage medium which stores the instructions in a non-volatile manner. Alternative examples of suitable computer readable storage media include tangible articles of manufacture and apparatus such as CD-ROM, flash memory, disk memory, tape memory, and the like.

What is claimed is:

1. In a computer system within a customer support center supporting a product of a company, a method of providing, to a customer of the company, a solution to a customer problem concerning the product, the method comprising:
receiving, by a controller of the computer system, a message from the customer that includes a description of the customer problem;
assigning, by the controller, a metric to the customer problem, the metric being based on the description of the customer problem;
performing, by the controller, a decision procedure based on the metric, the decision procedure being configured to cause the controller to send the message to one of i) internal resources of the company, and ii) external resources outside of the company; and
acquiring, by the controller, the solution of the customer problem from the one of the internal resources and the external resources.

2. A method as in claim 1,
wherein the metric includes a severity level; and
wherein performing the decision procedure includes:
sending the message to the internal resources when the severity level is greater than a severity level threshold, and
sending the message to the external resources when the severity level is less than or equal to the severity level threshold.

3. A method as in claim 2,
wherein the external resources include a crowdsourced public forum; and
wherein sending the message to the external resources includes:
posting the message to the crowdsourced public forum.

4. A method as in claim 3,
wherein the crowdsourced public forum includes a set of user accounts, each user account of the set of user accounts belonging to a user of a set of users, each user of the set of users including a reputation score;
wherein posting the message to the crowdsourced public forum includes:
specifying a minimum reputation score for a user of the set of users to submit a solution to the customer problem, the minimum reputation score being based on the severity level assigned to the customer problem;
wherein acquiring the solution of the customer problem includes:
verifying that a user of the set of users submitting the solution has a reputation score greater than or equal to the minimum reputation score.

5. A method as in claim 2,
wherein assigning the metric further includes:
assigning a classification to the customer problem based on the description of the customer problem;
producing a classification number that is equal to the number of problems to which the classification was assigned; and
generating the severity level based on the classification number.

6. A method as in claim 5,
wherein the classification corresponds to a particular customer problem;
wherein assigning the metric to the customer problem further includes:
assigning a classification severity level to the classification when the classification corresponds to an unsolved customer problem, and
assigning the classification severity level to the customer problem;
wherein the method further comprises:
measuring a time during which the particular customer problem is unsolved,
increasing the classification severity level when the time during which the customer problem is unsolved increases beyond a threshold time, and
maintaining the classification severity level when the time during which the customer problem is unsolved does not increase beyond the threshold time.

7. A method as in claim 6,
wherein the method further includes:
sending a communication to the customer, the communication including the solution, and
receiving, in response to the communication, another message from the customer that includes feedback indicating whether the solution was satisfactory;
when the feedback indicates that the solution was not satisfactory:
assigning another classification to the other message based on the feedback; and
when the feedback indicates that the solution was satisfactory:
generating, for problems to which the classification was assigned, a status indicating that the problems to which the classification was assigned correspond to a solved problem.

8. A system constructed and arranged to provide, to a customer of a company, a solution to a customer problem concerning a product of the company, the system comprising:
a network interface;
memory; and
a controller including controlling circuitry coupled to the memory, the controlling circuitry being constructed and arranged to:
receive, by a controller of the computer system, a message from the customer that includes a description of the customer problem;
assign, by the controller, a metric to the customer problem, the metric being based on the description of the customer problem;
perform, by the controller, a decision procedure based on the metric, the decision procedure being configured to cause the controller to send the message to one of i) internal resources of the company, and ii) external resources outside of the company; and
acquire, by the controller, the solution of the customer problem from the one of the internal resources and the external resources.

9. A system as in claim 8,
wherein the metric includes a severity level; and
wherein performing the decision procedure includes:
sending the message to the internal resources when the severity level is greater than a severity level threshold, and
sending the message to the external resources when the severity level is less than or equal to the severity level threshold.

10. A system as in claim 9,
wherein the external resources include a crowdsourced public forum; and
wherein sending the message to the external resources includes:
posting the message to the crowdsourced public forum.

11. A system as in claim 10,
wherein the crowdsourced public forum includes a set of user accounts, each user account of the set of user accounts belonging to a user of a set of users, each user of the set of users including a reputation score;
wherein posting the message to the crowdsourced public forum includes:
specifying a minimum reputation score for a user of the set of users to submit a solution to the customer problem, the minimum reputation score being based on the severity level assigned to the customer problem;
wherein acquiring the solution of the customer problem includes:
verifying that a user of the set of users submitting the solution has a reputation score greater than or equal to the minimum reputation score.

12. A system as in claim 9,
wherein assigning the metric further includes:
assigning a classification to the customer problem based on the description of the customer problem;
producing a classification number that is equal to the number of problems to which the classification was assigned; and
generating the severity level based on the classification number.

13. A system as in claim 12,
wherein the classification corresponds to a particular customer problem;
wherein assigning the metric to the customer problem further includes:
assigning a classification severity level to the classification when the classification corresponds to an unsolved customer problem, and
assigning the classification severity level to the customer problem;
wherein the method further comprises:
measuring a time during which the particular customer problem is unsolved,
increasing the classification severity level when the time during which the customer problem is unsolved increases beyond a threshold time, and
maintaining the classification severity level when the time during which the customer problem is unsolved does not increase beyond the threshold time.

14. A system as in claim 13,
wherein the controlling circuitry is further constructed and arranged to:
send a communication to the customer, the communication including the solution, and
receive, in response to the communication, another message from the customer that includes feedback indicating whether the solution was satisfactory;
when the feedback indicates that the solution was not satisfactory:
assign another classification to the other message based on the feedback; and
when the feedback indicates that the solution was satisfactory:
generate, for problems to which the classification was assigned, a status indicating that the problems to which the classification was assigned correspond to a solved problem.

15. A computer program product having a non-transitory, computer-readable storage medium which stores code to provide, to a customer of a company, a solution to a customer problem concerning a product of the company, the code including instructions to:
receive, by a controller of the computer system, a message from the customer that includes a description of the customer problem;
assign, by the controller, a metric to the customer problem, the metric being based on the description of the customer problem;
perform, by the controller, a decision procedure based on the metric, the decision procedure being configured to cause the controller to send the message to one of i) internal resources of the company, and ii) external resources outside of the company; and
acquire, by the controller, the solution of the customer problem from the one of the internal resources and the external resources.

16. A computer program product as in claim 15,
wherein the metric includes a severity level; and
wherein performing the decision procedure includes:
sending the message to the internal resources when the severity level is greater than a severity level threshold, and
sending the message to the external resources when the severity level is less than or equal to the severity level threshold.

17. A computer program product as in claim 16,
wherein the external resources include a crowdsourced public forum; and
wherein sending the message to the external resources includes:
posting the message to the crowdsourced public forum.

18. A computer program product as in claim 17,
wherein the crowdsourced public forum includes a set of user accounts, each user account of the set of user accounts belonging to a user of a set of users, each user of the set of users including a reputation score;
wherein posting the message to the crowdsourced public forum includes:
specifying a minimum reputation score for a user of the set of users to submit a solution to the customer problem, the minimum reputation score being based on the severity level assigned to the customer problem;
wherein acquiring the solution of the customer problem includes:
verifying that a user of the set of users submitting the solution has a reputation score greater than or equal to the minimum reputation score.

19. A computer program product as in claim 16,
wherein assigning the metric further includes:
assigning a classification to the customer problem based on the description of the customer problem;
producing a classification number that is equal to the number of problems to which the classification was assigned; and
generating the severity level based on the classification number.

20. A computer program product as in claim 19,
wherein the classification corresponds to a particular customer problem;
wherein assigning the metric to the customer problem further includes:
assigning a classification severity level to the classification when the classification corresponds to an unsolved customer problem, and
assigning the classification severity level to the customer problem;
wherein the method further comprises:
measuring a time during which the particular customer problem is unsolved,
increasing the classification severity level when the time during which the customer problem is unsolved increases beyond a threshold time, and
maintaining the classification severity level when the time during which the customer problem is unsolved does not increase beyond the threshold time.
